(19) United States
(12) Patent Application Publication
(10) Pub. No.: US 2021/0382601 A1
(43) Pub. Date: Dec. 9, 2021

(54) DISPLAY APPARATUS, DISPLAY PANEL, MANUFACTURING METHOD AND DRIVING METHOD THEREOF

(71) Applicant: BOE TECHNOLOGY GROUP CO., LTD., Beijing (CN)

(72) Inventors: Shengji Yang, Beijing (CN); Xue Dong, Beijing (CN); Xiaochuan Chen, Beijing (CN); Hui Wang, Beijing (CN); Yanming Wang, Beijing (CN); Pengcheng Lu, Beijing (CN); Wei Liu, Beijing (CN); Zhi Wang, Beijing (CN); Lei Wang, Beijing (CN); Huijuan Wang, Beijing (CN)

(73) Assignee: BOE TECHNOLOGY GROUP CO., LTD., Beijing (CN)

(21) Appl. No.: 16/332,240

(22) PCT Filed: Jul. 11, 2018
(86) PCT No.: PCT/CN2018/095260

§ 371 Date: Mar. 11, 2019

(30) Foreign Application Priority Data
Sep. 27, 2017 (CN) 201710890666.2

(51) Int. Cl. G06F 3/041; G06F 3/044; H01L 27/32

(52) U.S. Cl. CPC G06F 3/04184; G06F 3/0448; G06F 3/0443; G06F 2203/04103; G06F 3/04164; H01L 27/323; G06F 3/0412

(57) ABSTRACT

A display panel includes a touch electrode layer (4). The touch electrode layer (4) may include a plurality of touch electrodes (41). Each of the plurality of the touch electronics (41) may be insulated from one another. A shape of each of the plurality of the touch electronics (41) may be configured to determine a distance of a touch position on one of the plurality of the touch electrodes (41) to a geometric center of the touch electrode layer (4) based on a change of a capacitance of each of the plurality of the touch electrodes (41).

### CROSS-REFERENCE TO RELATED APPLICATIONS

This application claims benefit of the filing date of Chinese Patent Application No. 201710890666.2 filed on Sep. 27, 2017, the disclosure of which is hereby incorporated in its entirety by reference.

### TECHNICAL FIELD

This invention relates to touch technology, and more particularly, to a display apparatus, a display panel, a manufacturing method and a driving method thereof.

### BACKGROUND

At present, OLED (Organic Light-Emitting Diode) screens have been widely used in electronic devices such as mobile phones and tablet computers because of their advantages of low energy consumption, wide viewing angle and fast response speed. Meanwhile, with the development of touch technology, the touch screens based on OLED screens came into being. The existing touch screen generally includes two types: a resistive touch screen and a capacitive touch screen. Between them, an active-matrix organic light emitting diode (AMOLED) touch screen is very popular.

It should be noted that the information disclosed in the above background section is only for the enhancement of understanding of the background of the present disclosure and therefore can include other information that does not form the related art that is already known to one of ordinary skill in the art.

### BRIEF SUMMARY

Accordingly, one example of the present disclosure is a display panel. The display panel may include a touch electrode layer. The touch electrode layer may include a plurality of touch electrodes. Each of the plurality of the touch electrodes may be insulated from one another. A shape of each of the plurality of the touch electrodes may be configured to determine a distance of a touch position on one of the plurality of the touch electrodes to a geometric center of the touch electrode layer based on a change of a capacitance of each of the plurality of the touch electrodes.

In one embodiment, the plurality of the touch electrodes may be radially distributed around the geometric center of the touch electrode layer and expanded outwardly from the geometric center.

In one embodiment, each of the plurality of the touch electrodes may have a same shape and a same area.

In one embodiment, the touch electrode layer is circular, and each of the plurality of the touch electrodes has a fan-shape.

In one embodiment, a terminal may be disposed at an outer edge of each of the touch electrodes and the terminal is configured to connect to a wire. The wire may surround a periphery of the touch electrode layer and be connected with a touch driving unit. There may be a gap between every adjacent two of the fan-shaped touch electrodes.

In one embodiment, the display panel may further include a first electrode layer on a base substrate, an organic light-emitting layer on the first electrode layer, and a second electrode layer on the organic light-emitting layer. The second electrode layer and the touch electrode layer may be the same electrode layer. The second electrode layer may be on a side of the first electrode layer away from the base substrate. The first electrode layer may be an anode of the display panel and the second electrode layer may be a cathode of the display panel.

Another example of the present disclosure is a driving method for driving the touch panel according to one embodiment of the present disclosure. The driving method may include providing a first driving signal to the touch electrode layer during a touch period, detecting a change of a capacitance of each of the touch electrodes and sending a touch signal based on the change of the capacitance, and determining a touch position based on the touch signal.

In one embodiment, determining the touch position based on the touch signal may include determining a polar coordinate of the touch position in a polar coordinate system based on a position of the touch electrode corresponding to the touch signal and determining a touch area of the touch position based on the touch signal and determining a polar radius coordinate of the touch position in the polar coordinate system based on the touch area.

The driving method may further include providing a second driving signal to the second electrode layer during a display period. The first electrode layer may float during the touch period.

Another example of the present disclosure is a method of fabricating a display panel. The method of fabricating a display panel may include providing a base substrate and forming a touch electrode layer on the base substrate, the touch electrode layer comprising a plurality of touch electrodes. The touch electrodes may be radially distributed around a center of the touch electrode layer and expanded outwardly from the center, and two adjacent touch electrodes may be insulated from each other.

In one embodiment, forming the touch electrode layer may include forming a photoresist layer, the photoresist layer comprising a plurality of partition bars, each of the partition bars being radially distributed, and a gap being formed between every two adjacent partition bars, forming a touch metal layer covering the photoresist layer, and removing the photoresist layer and the touch metal layer covering the partition bars to form the touch electrode layer. Each of the partition bars may have an inverted trapezoid shape.

In one embodiment, forming the touch electrode layer may include forming a touch metal layer and patterning the touch metal layer to form the touch electrode layer.

The method of fabricating a display panel may further include forming a first electrode layer on the base substrate, forming an organic light-emitting layer on the first electrode layer, and forming a second electrode layer on the organic light-emitting layer. The second electrode layer and the touch electrode layer may be the same electrode layer.

Another example of the present disclosure is a display apparatus. The display apparatus may include a display panel according to any one of the present disclosure.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a cross-sectional view of a display panel according to an embodiment of the present disclosure;

FIG. 2 is a schematic diagram of touch electrodes of a touch panel according to an embodiment of the present disclosure;

FIG. 3 is a schematic diagram of a touch panel connected with conducting wires according to an embodiment of the present disclosure;

FIG. 4 is a flowchart of a touch panel driving method according to an embodiment of the present disclosure;

FIG. 5 is a flowchart of step S130 in FIG. 4 according to an embodiment of the present disclosure;

FIG. 6 is a flowchart of a method of manufacturing a touch panel according to an embodiment of the present disclosure;

FIG. 7 is a flowchart of step S240 in FIG. 6 according to an embodiment of the present disclosure;

FIG. 8 is a flowchart of step S240 in FIG. 6 according to an embodiment of the present disclosure;

FIG. 9 is a schematic diagram corresponding to step S2410 in FIG. 7 according to an embodiment of the present disclosure;

FIG. 10 is a schematic diagram corresponding to step S2420 in FIG. 7 according to an embodiment of the present disclosure; and

FIG. 11 is a schematic diagram corresponding to step S2430 in FIG. 7 according to an embodiment of the present disclosure.

### DETAILED DESCRIPTION

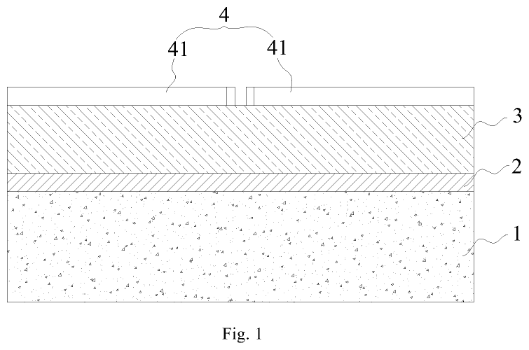

The present disclosure will be described in further detail with reference to the accompanying drawings and embodiments in order to provide a better understanding by those skilled in the art of the technical solutions of the present disclosure. Throughout the description of the disclosure, reference is made to FIGS. 1-11. When referring to the figures, like structures and elements shown throughout are indicated with like reference numerals.

Although relative terms such as “up” and “down” are used in this specification to describe relative relationship of one component of a figure to another, these terms are used herein for convenience only, e.g., according to the direction exemplified in the drawings. It should be understood that if a device in a figure is flipped so it is upside down, the component described as “up” will become the component under “down.” When a structure is “on” another structure, it is possible that the structure is integrally formed on another structure, that the structure is “disposed directly” on another structure, or that the structure is “indirectly” placed on another structure through other structures.

The terms “a,” “an,” “the,” and “said” are used to indicate the presence of one or more elements/components/etc. The terms “comprising” and “having” are intended to mean inclusive and that there may be additional elements/components other than the listed elements/components/etc.

In this specification, the terms “first” and “second” may be added as prefixes. These prefixes, however, are only added in order to distinguish the terms and do not have specific meaning such as order and relative merits.

In the related art, an in-cell self-capacitive AMOLED touch screen usually includes a touch electrode, a touch driving unit, etc. Since the touch electrode and the touch driving unit are not located on the same layer, each touch electrode usually needs to be connected to the touch driving unit by a through hole and a metal wire. The metal wire is located on the same layer as the touch driving unit. Alternatively, a plurality of lead wires connected with the touch electrodes and in the same layer with the touch electrodes may be formed simultaneously with the touch electrodes. The touch electrodes are connected to the touch driving unit through the respective lead wires.

However, opening through holes in the touch screen will make the aperture ratio lower, thereby affecting the display effect. Furthermore, in the manufacturing process, a high-precision metal mask process is used, thereby affecting product yield and increasing amount of material used and the cost. Furthermore, the formation of dedicated lead wires will squeeze the space occupied by the touch electrodes, thereby resulting in touch electrodes of different sizes and forming touch blind zones in the areas where the lead wires are located. At the same time, due to different lengths of the lead wires, resistance values of the lead wires are greatly different, which may cause problems, for example, that the voltage drop is too large, thereby affecting the touch effect.

One example of the present disclosure is a touch panel for a display apparatus. As shown in FIG. 1 to FIG. 3, the touch panel according to this embodiment may include a base substrate 1, a first electrode layer 2, an organic light-emitting layer 3, a second electrode layer, and a touch electrode layer 4.

In one embodiment, the base substrate 1 may be made of a glass material such as borosilicate glass or the like. The shape of the base substrate 1 may be circular, rectangular or other shapes.

The first electrode layer 2 may be formed on the base substrate 1 and in the same shape as the base substrate 1. The first electrode layer 2 may be made of a transparent conductive material, such as indium tin oxide or the like. The first electrode layer 2 may serve as a connecting layer for a positive voltage of the organic electroluminescent apparatus, i.e., an anode.

The organic light-emitting layer 3 may be disposed on the first electrode layer 2 and in the same shape as the first electrode layer 2. Furthermore, the organic light-emitting layer 3 may be a fluorescent organic material, an organic material doped with a phosphorescent material, or the like. The organic light-emitting layer 3 may include a plurality of organic light-emitting units. For specific structure of the organic light-emitting layer 3, reference may be made to the organic light-emitting layer 3 in the related art, and details thereof are not described herein again.

The second electrode layer may be formed on the organic light-emitting layer 3 and may have the same shape as the organic light-emitting layer 3. The second electrode layer may also be a transparent conductive material such as indium tin oxide. The second electrode layer may serve as a connecting layer for a negative voltage of the organic electroluminescent apparatus, i.e., a cathode.

It should be noted that, the first electrode layer 2, the organic light-emitting layer 3, and the second electrode layer may together form an organic electroluminescent apparatus. For the principle thereof, reference may be made to the existing AMOLED touch panel, and details thereof are not described herein again.

In one embodiment, the touch electrode layer 4 can be the same electrode layer as the second electrode layer. That is, the touch electrode layer 4 can be disposed on the organic light-emitting layer 3 and reused as the second electrode layer, thereby simplifying the structure.

In one embodiment, the display panel includes a touch electrode layer. The touch electrode layer includes a plurality of touch electrodes. Each of the plurality of the touch electrodes is insulated from one another. A shape of each of the plurality of the touch electrodes is configured to determine a distance of a touch position on one of the plurality of the touch electrodes to a geometric center of the touch electrode layer based on a change of a capacitance of each of the plurality of the touch electrodes.

In one embodiment, the plurality of the touch electrodes are radially distributed around the geometric center of the touch electrode layer and expanded outwardly from the geometric center. Each of the plurality of the touch electrodes may have a same shape and a same area.

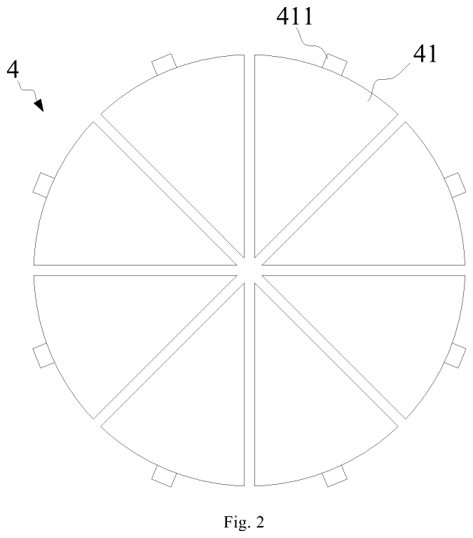

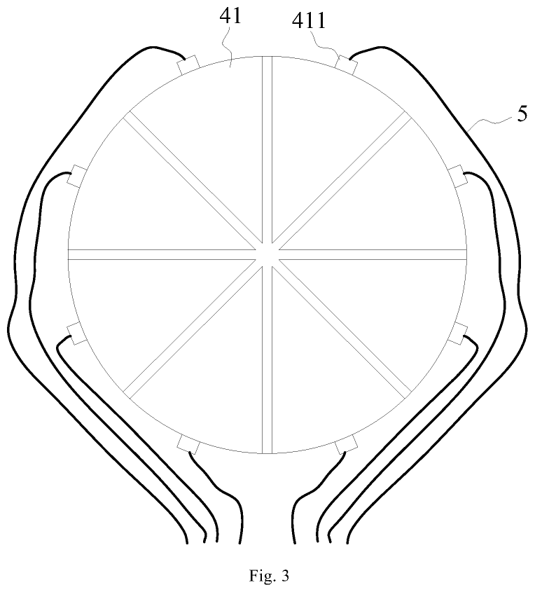

In one amendment, as shown in FIGS. 2 and 3, the touch electrode layer 4 may be circular and include a plurality of touch electrodes 41. Each of the touch electrodes 41 may be fan-shaped. Specific dimensions thereof are not limited herein, but the shapes and sizes of the touch electrodes 41 are almost the same. The plurality of touch electrodes 41 may be radially distributed around the center of the touch electrode layer 4 and do not overlap with one another. A gap or an insulation bar may be disposed between two adjacent touch electrodes 41 to ensure that insulation is maintained between the two adjacent touch electrodes 41.

The shape of the touch electrode is not limited herein. The touch electrode may have other shapes such as a triangle shape or a rectangular shape as long as the shape of each of the plurality of the touch electrodes may be configured to determine a distance of a touch position on one of the plurality of the touch electrodes to a geometric center of the touch electrode layer based on a change of a capacitance of each of the plurality of the touch electrodes. For a touch electrode having a shape without an axis of symmetry, a correspondence relationship between the area of the touch electrode and the generated capacitance can be stored in a drive circuit or a control chip.

In one embodiment, a terminal 411 may be disposed at an outer edge of each touch electrode 41, i.e., an end away from the center of the touch electrode layer 4. The terminal 411 and the touch electrode 41 may be a unitary structure. As shown in FIG. 3, each of the terminals 411 may be connected with a wire 5, and each wire 5 may surround the periphery of the touch electrode layer 4 and be connected with the touch driving unit. The touch driving unit may be a touch driving circuit or other apparatuses having the same function.

Since the capacitance of the touch electrode has a linear relationship with the touch area of the touch position and the touch area has a linear relationship with a distance of the touch position relative to the center of the touch electrode layer, the touch position can be determined based on the capacitance of the touch electrode. The specific principle thereof is described below in disclosure of the touch panel driving method, which will not be described in detail herein.

It should be noted that this embodiment, in which the touch electrode layer 4 and the second electrode layer are the same electrode layer, is an example. In other embodiments of the present disclosure, the touch electrode layer 4 and the second electrode layer may also be different electrode layers, and the touch electrode layer 4 may be disposed on the second electrode layer, and will not be described in detail here.

In the touch panel according to one embodiment, the touch electrodes 41 can be respectively connected to a touch driving unit by a plurality of wires 5 to avoid connecting via through holes, thereby reducing difficulty of the process and the cost. Each conductive wire 5 can be distributed along the periphery of the touch electrode layer 4 without passing through the touch electrode layer 4 to avoid inconsistencies of touch electrodes due to the distribution of the conductive wires 5 and to prevent occurrence of touch blind spots and large drop of pressures.

The touch panel according to one embodiment may further include other components. For details of the other components, reference may be made to the existing AMOLED touch panel, which is not described herein in detail.

Another example of the present disclosure is a touch panel driving method for driving the touch panel of any one of the above. For specific structure of the touch panel, reference may be made to an exemplary embodiment of the touch panel described above, and details are not described herein again.

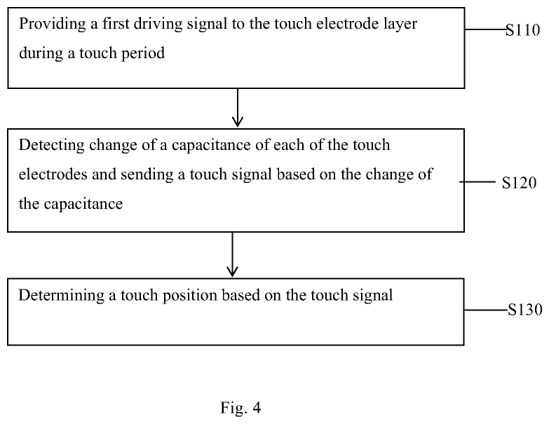

In one embodiment, as shown in FIG. 4, the touch panel driving method may include:

In step S110, a first driving signal is provided to the touch electrode layer 4 during a touch period.

In step S120, a change of capacitance of each of the touch electrodes 41 is detected, and accordingly a touch signal is sent.

In step S130, a touch position is determined based on the touch signal.

In the touch panel driving method according to this embodiment, a first driving signal is provided to the touch electrode layer 4 during a touch period, and a touch signal is sent based on a change in capacitance of the touch electrode 41. Then, the touch position can be determined based on the change in capacitance of the touch electrode 41, thereby realizing touch function of the touch panel.

In the following, each step of the touch panel driving method in the exemplary embodiment will be further described.

In step S110, a first driving signal is provided to the touch electrode layer 4 during a touch period.

In one embodiment, because the touch electrode layer 4 can be reused as the second electrode layer, the touch electrode layer 4 can be driven in a time-division manner. The driving period of the touch panel may be divided into a touch period and a display period, and durations of the touch period and the display period are not limited herein.

In the touch period, the touch driving unit may provide a first driving signal to each touch electrode 41 of the touch electrode layer 4 so as to detect change of the capacitance between the touch electrode 41 and a user's finger in order to realize touch function. In addition, the first electrode layer 2 of the touch panel may be floated, and signal waveforms from other lines of the touch panel such as gate lines and signal lines may be synchronized with the first driving signal so as to reduce load on the touch electrode 4 to ground (ground loading).

In the display period, a second driving signal may be provided to each of the touch electrodes 41 of the touch electrode layer 4 by a display driving device so that the touch electrode layer 4 functions as a cathode. At the same time, the first electrode layer 2 can serve as an anode. At this time, the first electrode layer 2, the organic light-emitting layer 3, and the touch electrode layer 4 can form an organic electroluminescent apparatus to realize the display function. The specific principle thereof may be found in the existing principle of organic electroluminescence, which is not described in detail herein.

In step S120, change of capacitance of each of the touch electrodes 41 is detected, and accordingly a touch signal is sent.

In one embodiment, when the touch electrode 41 is touched, the capacitance of the touch position will change. The touch driving unit may detect a change of the capacitance and generate a corresponding touch signal. The touch signal may include the capacitance information of the touch electrode 41 corresponding to the touch position, but not limited thereto. Other information may also be included.

In step S130, a touch position is determined based on the touch signal.

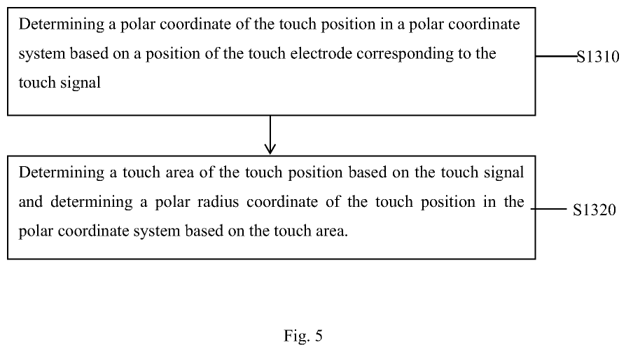

In one embodiment, as shown in FIG. 5, determining the touch position based on the touch signal may include steps S1310 and S1320.

In step S1310, a polar coordinate of the touch position in a polar coordinate system is determined based on the position of the touch electrode 41 corresponding to the touch signal.

A polar coordinate system can be constructed. Each touch electrode 41 corresponds to a different polar coordinate. The distance between any position on a same touch electrode 41 and the center of the touch electrode layer 4 is a polar radius coordinate of the position, so that any position on each of the touch electrodes 41 has a different polar coordinate. The corresponding touch electrode 41 that sends the touch signal may be determined according to the touch signal, thereby determining the polar coordinate of the touch position in the polar coordinate system.

In step S1320, a touch area of the touch position is determined based on the touch signal, and a polar radius coordinate of the touch position in the polar coordinate system is then determined based on the touch area.

Since the capacitance of the touch electrode 41 has a linear relationship with the touch area of the touch position, it can be specifically determined according to a well-known formula for calculating the capacitance and will not be described in detail here. Thus, the touch area can be determined based on the information of the capacitance change contained in the touch signal.

As the fan shape gradually expands outwardly from the center, on the touch electrode 41, the closer the touch position to the center of the touch electrode layer 4, the smaller the touch area. The farther away from the center of the touch electrode layer 4 the touch position is, the larger the touch area. The touch area has a linear relationship with the distance of the touch position relative to the center of the touch electrode layer 4. Therefore, the distance between the touch position and the center of the touch electrode layer 4 can be determined according to the touch area so as to obtain the polar radius coordinate of the touch position in the above polar coordinate system.

Accordingly, accurate position of the touch position on the touch electrode layer 4 can be determined according to the polar coordinates and the polar radius coordinates described above, thereby realizing the corresponding touch function.

It should be noted that the above principle of determining the touch position by the touch electrode layer 4 is merely exemplary. In other exemplary embodiments of the present disclosure, the touch position may also be determined in other ways, and are not listed herein.

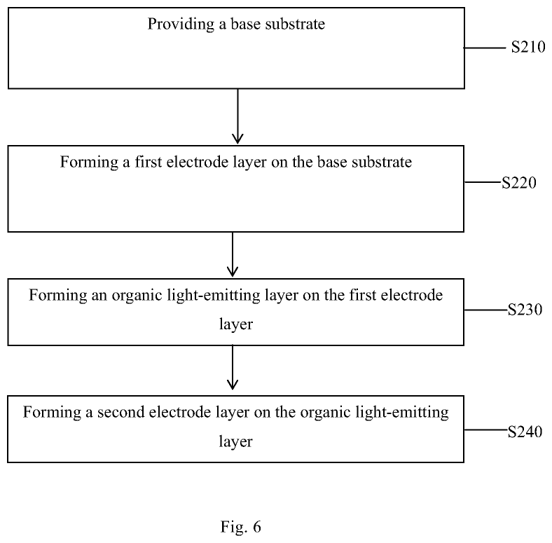

Another exemplary embodiment of the present disclosure provides a method of manufacturing a touch panel of any one of the above. As shown in FIG. 1 and FIG. 6, the method of manufacturing the touch panel of this exemplary embodiment may include:

In step S210, a base substrate 1 is provided.

In step S220, a first electrode layer 2 is formed on the base substrate.

In step S230, an organic light-emitting layer 3 is formed on the first electrode layer 2.

In step S240, a touch electrode layer 4 is formed on the organic light-emitting layer 3. The touch electrode layer 4 is circular and includes a plurality of fan-shaped touch electrodes 41. Each of the touch electrodes 41 is radially distributed, and two adjacent touch electrodes 41 are insulated from each other. Meanwhile, the touch electrode layer 4 may also serve as the second electrode layer.

The method of manufacturing the touch panel of this exemplary embodiment may be used to manufacture the touch panel of any one of the above embodiments. Therefore, for advantages of the method of manufacturing the touch panel of this exemplary embodiment, reference may be made to the beneficial effects of the above touch panel, and not described further herein.

In the following, each step of the method of manufacturing the touch panel in the present exemplary embodiment will be further described.

In step S210, for the base substrate 1, reference may be made to the base substrate 1 in the above exemplary touch panel embodiment and the details thereof are not described herein again.

In step S220, a first electrode layer 2 is formed on the base substrate.

In one embodiment, the first electrode layer 2 may be an anode. The first electrode layer 2 may be formed by a photolithography process, a printing process, and the like. For details, reference may be made to the existing anode formation process, which is not described in detail herein.

In step S230, an organic light-emitting layer 3 is formed on the first electrode layer 2.

In one embodiment, the organic light-emitting layer 3 may include a plurality of light-emitting units. The formation process of the organic light-emitting layer 3 may refer to the formation process of the existing organic light-emitting layer and will not be described in detail here.

In step S240, there are many ways of forming the touch electrode layer 4. For example, first Embodiment of forming the touch control electrode layer 4 may include the following:

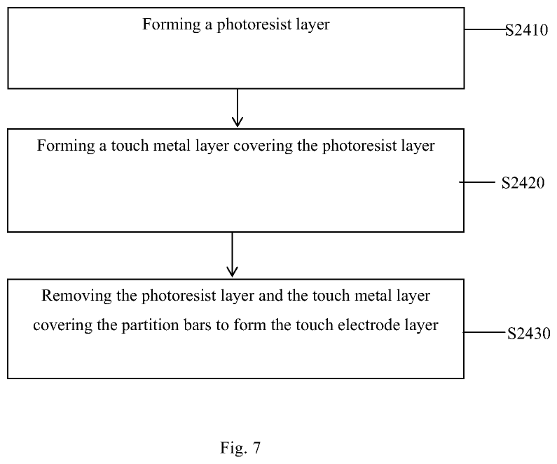

As shown in FIG. 7, forming the touch electrode layer 4 may include steps S2410 to S2430. In step S2410, a photoresist layer 6 is formed. The photoresist layer 6 includes a plurality of partition bars 61. Each partition bar 61 is radially distributed, and gaps are formed between two adjacent partition bars 61.

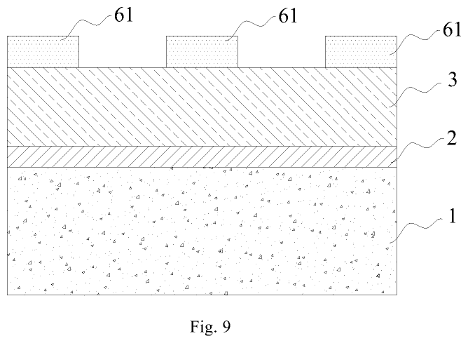

As shown in FIG. 9, the photoresist layer 6 can be formed by coating, and then a plurality of partition bars 61 are sequentially formed through exposure and development processes. A region between two adjacent partition bars 61 is used for forming a touch control electrode 41. In one embodiment, the shape of the partition bar 61 may be inverted trapezoidal, that is, its cross section is inverted trapezoidal. Of course, the shape of the partition bar 61 may also be rectangular or other shapes. The photoresist can be negative or positive.

In step S2420, a touch metal layer 7 covering the photoresist layer 6 is formed by a vapor deposition process.

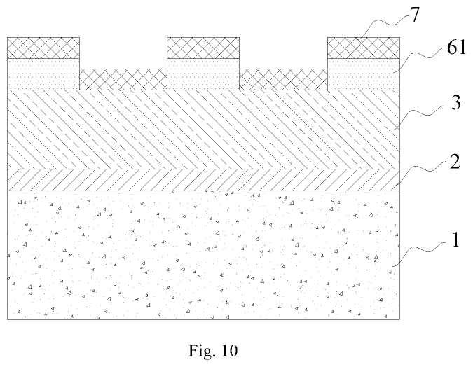

As shown in FIG. 10, the touch metal layer 7 formed by the vapor deposition process can cover each of the partition bars 6 and simultaneously cover the area between two adjacent partition bars 61. But the touch metal layer 7 covering the partition bar 61 and the touch metal layer 7 covering the region between the adjacent two partition bars 61 are disconnected due to presence of the partition bar 61. The touch-control metal layer 7 covering the region between the two adjacent partition bars 61 is the touch electrode 41. The touch metal layer 7 may be made of a transparent conductive material such as indium tin oxide.

In step S2430, the photoresist layer 6 and the touch metal layer 7 covering the partition bar 61 are removed to form the touch electrode layer 4.

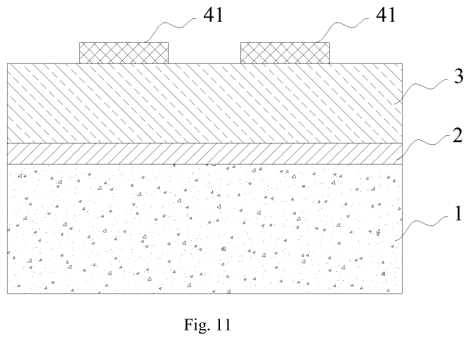

As shown in FIG. 11, the photoresist layer 6 can be removed by an ashing process. The touch metal layer 7 covering the partition bar 61 can be removed while the partition bar 61 is removed, and the touch metal layer 7 in the regions between adjacent two partition bars 61 is maintained. That is, the touch electrode 41 remains, thereby obtaining the touch electrode layer 4. Of course, the photoresist layer 6 and the touch metal layer 7 that covers the partition bar 61 can also be removed by other methods that will not be listed here.

It should be noted that FIG. 9 to FIG. 11 only serve to illustrate the principle of the first embodiment of forming the touch electrode layer 4 and not to be drawn according to the actual structure of the touch panel.

The second embodiment of forming the touch electrode layer 4 may include the following:

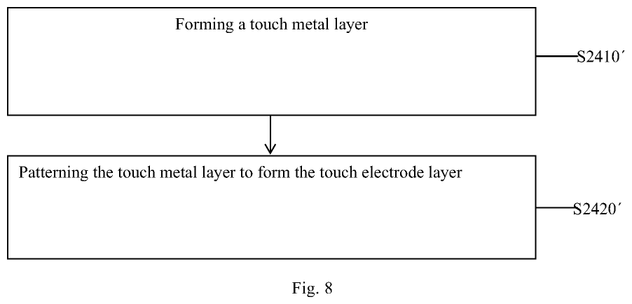

As shown in FIG. 8, forming the touch electrode layer 4 may include steps S2410′ and S2420′.

In step S2410′, a touch metal layer 7′ is formed.

The manner of forming the touch metal layer 7′ may be chemical vapor deposition, vapor deposition, ion plating or the like, which is not limited herein.

In step S2420′, the touch metal layer 7′ is patterned to form the touch electrode layer.

The above patterning process may include steps of depositing the touch metal layer 7′, coating photoresist, exposing, developing, and etching. For details, reference may be made to the existing patterning process, which is not described in detail herein. Thus, the touch electrode layer 4 can be formed.

In other exemplary embodiments of the present disclosure, the above-mentioned touch electrode layer 4 may also be formed by other methods such as laser engraving, printing, etc., that will not be listed here one by one

The exemplary embodiments of the present disclosure further provide a display apparatus. The display apparatus of this exemplary embodiment may include a touch panel according to one embodiment of the present disclosure. The display apparatus can be used in electronic devices such as electronic watches and the like, and will not be listed here. Beneficial effects of the display apparatus in this exemplary embodiment may refer to the beneficial effects of the above touch panel, which are not described in detail herein.

The display apparatus in this exemplary embodiment may further include other components. For details, reference may be made to the existing AMOLED display apparatus, which is not described herein in detail.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A display panel, comprising
a touch electrode layer, the touch electrode layer comprising a plurality of touch electrodes, each of the plurality of the touch electrodes being insulated from one another;
wherein a shape of each of the plurality of the touch electrodes is configured to determine a distance of a touch position on one of the plurality of the touch electrodes to a geometric center of the touch electrode layer based on a change of a capacitance of each of the plurality of the touch electrodes.

2. The display panel according to claim 1, wherein the plurality of the touch electrodes are radially distributed around the geometric center of the touch electrode layer and expanded outwardly from the geometric center.

3. The display panel according to claim 1, wherein the touch electrode layer is circular, and each of the plurality of the touch electrodes has a fan-shape.

4. The display panel according to claim 1, wherein each of the plurality of the touch electrodes has a same shape and a same area.

5. The display panel according to claim 1, wherein a terminal is disposed at an outer edge of each of the touch electrodes and the terminal is configured to connect to a wire.

6. The display panel according to claim 5, wherein the wire surrounds a periphery of the touch electrode layer and is connected with a touch driving unit.

7. The display panel according to claim 1, wherein there is a gap between every adjacent two of the touch electrodes.

8. The display panel according to claim 1, further comprising:
a first electrode layer on a base substrate;
an organic light-emitting layer on the first electrode layer; and
a second electrode layer on the organic light-emitting layer.

9. The display panel according to claim 8, wherein the second electrode layer and the touch electrode layer are the same electrode layer.

10. The display panel according to claim 8, wherein the second electrode layer is on a side of the first electrode layer away from the base substrate.

11. The display panel according to claim 8, wherein the first electrode layer is an anode of the display panel and the second electrode layer is a cathode of the display panel.

12. A driving method for driving the touch panel according to claim 1, comprising:
providing a first driving signal to the touch electrode layer during a touch period;
detecting a change of a capacitance of each of the touch electrodes and sending a touch signal based on the change of the capacitance; and
determining a touch position based on the touch signal.

13. The driving method according to claim 12, wherein determining the touch position based on the touch signal comprising:
determining a polar coordinate of the touch position in a polar coordinate system based on a position of the touch electrode corresponding to the touch signal; and
determining a touch area of the touch position based on the touch signal and determining a polar radius coordinate of the touch position in the polar coordinate system based on the touch area.

14. The driving method according to claim 12, further comprising providing a second driving signal to the second electrode layer during a display period.

15. (canceled)

16. A method of fabricating a display panel, comprising:
providing a base substrate; and
forming a touch electrode layer on the base substrate, the touch electrode layer comprising a plurality of touch electrodes,
wherein the touch electrodes are radially distributed around a center of the touch electrode layer and expanded outwardly from the center, and two adjacent touch electrodes are insulated from each other.

17. The method of fabricating a display panel according to claim 16, wherein forming the touch electrode layer comprises:
forming a photoresist layer, the photoresist layer comprising a plurality of partition bars, each of the partition bars being radially distributed, and a gap being formed between every two adjacent partition bars;
forming a touch metal layer covering the photoresist layer; and
removing the photoresist layer and the touch metal layer covering the partition bars to form the touch electrode layer.

18. The method of fabricating a display panel according to claim 17, wherein each of the partition bars has an inverted trapezoid shape.

19. The method of fabricating a display panel according to claim 16, wherein forming the touch electrode layer comprises:
forming a touch metal layer; and
patterning the touch metal layer to form the touch electrode layer.

20. The method of fabricating a display panel according to claim 16, further comprising:
forming a first electrode layer on the base substrate;
forming an organic light-emitting layer on the first electrode layer; and
forming a second electrode layer on the organic light-emitting layer.

21. (canceled)

22. A display apparatus, comprising the display panel of claim 1.
